(19) United States
(12) Patent Application Publication
(10) Pub. No.: US 2026/0057026 A1
(43) Pub. Date: Feb. 26, 2026

(54) WEB BROWSING SYSTEM, COMMUNICATION TERMINAL, AND CONTROL METHOD FOR COMMUNICATION TERMINAL

(71) Applicant: CANON KABUSHIKI KAISHA, Tokyo (JP)

(72) Inventor: SORA KUMAGAI, Chiba (JP)

(21) Appl. No.: 19/375,009

(22) Filed: Oct. 30, 2025

Related U.S. Application Data
(63) Continuation of application No. 18/475,091, filed on Sep. 26, 2023, now abandoned.

(30) Foreign Application Priority Data
Sep. 29, 2022 (JP) 2022-156285

(51) Int. Cl. G06F 16/957; H04L 67/02

(52) U.S. Cl. CPC G06F 16/957; H04L 67/02

(57) ABSTRACT

In a cloud browsing system including an image generation server, an image forming apparatus, and a user terminal, the image forming apparatus transmits address information about a web page to the image generation server, the image generation server generates a rendering image of a web page corresponding to the address information and provides the rendering image to the image forming apparatus, the image forming apparatus generates a web page that is based on the rendering image, and the user terminal accesses the generated web page.

### CROSS REFERENCE OF RELATED APPLICATIONS

This application is a continuation of U.S. Patent Application No. 18/475,091, filed on September 26, 2023, which claims the benefit of Japanese Patent Application No. 2022-156285 filed September 29, 2022, which is hereby incorporated by reference herein in its entirety.

### BACKGROUND

### Field of the Disclosure

Aspects of the present disclosure generally relate to a communication terminal for use in a web browsing system. The communication terminal can be applied to not only image processing apparatuses including printers, scanners, facsimile (FAX) apparatuses, and multifunction peripherals configured with those but also general-purpose information processing apparatuses such as personal computers or mobile terminals.

### Description of the Related Art

Heretofore, there have been known communication terminals such as image processing apparatuses (information processing apparatuses) each equipped with a web browser (hereinafter referred to as a “browser”) and having a function enabling the user to view a web page on the browser. The communication terminal, having accessed a web page of an external service via the web browser, is able to expand the function thereof by cooperating with the external service.

Nowadays, a contrivance called a cloud browser, which uses an image generation server that generates a drawing result of a web page on a cloud server, is under consideration. Japanese Patent Application Laid-Open No. 2022-41717 discusses a system in which a web page is rendered by a virtual machine located on a network different from that for a communication terminal and a result of such rendering is displayed on the communication terminal.

### SUMMARY

According to an aspect of the present disclosure, a web browsing system includes a server configured to perform rendering on a web page, a communication terminal configured to perform displaying of the web page based on a result of the rendering, and an external apparatus configured to communicate with the communication terminal, wherein the communication terminal includes a unit configured to transmit address information about a web page to the server, a unit configured to receive a rendering image of the web page from the server, and a unit configured to generate a further web page based on the rendering image, wherein the server includes a unit configured to receive the address information from the communication terminal, and a unit configured to access the web page based on the address information, generate a rendering image based on the web page, and transmit the generated rendering image to the communication terminal, and wherein the external apparatus includes a unit configured to acquire the further web page, and a unit configured to display, on a display unit, a screen that is based on the further web page.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of a cloud browser system.

FIG. 2A is a block diagram illustrating a hardware configuration example of a virtual machine, and FIG. 2B is a block diagram illustrating a software configuration example of the virtual machine.

FIG. 3A is a block diagram illustrating a hardware configuration example of an image forming apparatus, and FIG. 3B is a block diagram illustrating a software configuration example of the image forming apparatus.

FIG. 4 is a diagram illustrating an example of a setting screen which operates in the cloud browser system.

FIG. 5 is a diagram illustrating an example of a home screen which is displayed in the image forming apparatus.

FIG. 6 is a diagram illustrating an example of a screen which is generated in the cloud browser system.

FIGS. 7A and 7B are sequence diagrams illustrating a procedure of processing which the cloud browser system performs.

FIG. 8 is a block diagram illustrating a hardware configuration example of a user terminal.

FIG. 9A is a diagram illustrating an example of a menu screen which is used in a cloud browser application, and FIG. 9B is a diagram illustrating an example of a connection guide screen for the user terminal.

FIG. 10 is a diagram illustrating an example of a screen displayed on the user terminal when the user terminal has accessed the cloud browser system.

FIG. 11A is a diagram illustrating an example of a screen displayed on the image forming apparatus when the user terminal is connecting to the image forming apparatus, and FIG. 11B is a diagram illustrating an example of another screen displayed on the image forming apparatus when the user terminal is connecting to the image forming apparatus.

FIGS. 12A and 12B are sequence diagrams illustrating a procedure of processing which the cloud browser system performs during connection of the user terminal.

FIG. 13A is a diagram illustrating an example of a web page used for performing setting of a web service, and FIG. 13B is a diagram illustrating an example of another web page used for performing setting of a web service.

FIG. 14A is a flowchart of processing which the image forming apparatus performs when the user terminal is connecting to the image forming apparatus, and FIG. 14B is a flowchart of processing which the image forming apparatus performs when the user terminal is connecting to the image forming apparatus.

FIG. 15 is a diagram illustrating an example of a web page used for performing setting of a web service.

### DESCRIPTION OF THE EMBODIMENTS

Various exemplary embodiments, features, and aspects of the disclosure will be described in detail below with reference to the drawings. Furthermore, the scope of the disclosure is not limited to configurations described in the exemplary embodiments. Within the range available for obtaining similar advantageous effects, modifications or alterations such as substituting part of a configuration or part of processing with an equivalent or omitting part of a configuration or part of processing can be performed on the exemplary embodiments.

### Cloud Browser System

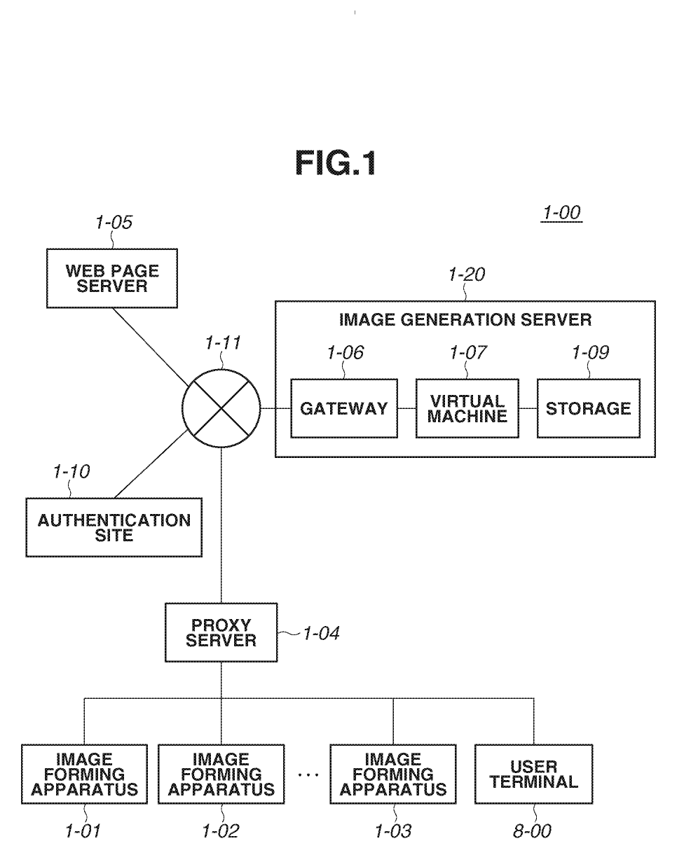

FIG. 1 is a diagram illustrating a configuration of the entirety of a cloud browser system. The cloud browser system 1-00 is a web browsing system which performs rendering of web content on cloud computing. The cloud browser system 1-00 includes a plurality of image forming apparatuses 1-01 to 1-03, and an image generation server 1-20 and a user terminal 8-00, to which these image forming apparatuses 1-01 to 1-03 connect. Moreover, the cloud browser system 1-00 includes a web page server 1-05 (a web content providing server), which provides a web page, a proxy server 1-04, and an authentication site 1-10, or cooperates with the web page server 1-05, the proxy server 1-04, and the authentication site 1-10 serving as external services. In FIG. 1, an example in which, while one image generation server 1-20 is included, three image forming apparatuses 1-01 to 1-03 are connected to the image generation server 1-20 is illustrated. However, the number of image forming apparatuses which are caused to connect to the image generation server 1-20 can be optional. Moreover, the number of user terminals can also be optional. Moreover, the image generation server 1-20 is configured to provide services to a plurality of image forming apparatuses in parallel or in a time-sharing manner. Therefore, within the cloud browser system 1-00, the number of image generation servers 1-20 is relatively smaller than the number of image forming apparatuses. Moreover, for the purpose of, for example, distributing load, a plurality of image generation servers can be located within the cloud browser system 1-00. In the following description, with regard to a relationship with the image generation server 1-20, description is performed with the image forming apparatus 1-01 taken as an example on behalf of a plurality of image forming apparatuses.

The image generation server 1-20 is a system on cloud computing which provides a service typified by rendering of web content. The image generation server 1-20 includes a gateway 1-06, a virtual machine 1-07, and a storage 1-09. Although details are described below, a browser engine, which is a software module, operates on the virtual machine 1-07 included in the image generation server 1-20. The browser engine receives, via the gateway 1-06, a Uniform Resource Locator (URL) of the web page server 1-05 transmitted from the image forming apparatus 1-01. Then, the browser engine accesses the web page server 1-05 corresponding to the received URL via the gateway 1-06, and thus receives web content of, for example, the HyperText Markup Language (HTML) from the web page server 1-05.

After that, a software module, which is separately prepared to perform rendering, generates a rendering result of the received web content. The rendering result is transmitted to the image forming apparatus 1-01 via the gateway 1-06.

Moreover, for simplifying description, the present exemplary embodiment is configured in such a manner that only one virtual machine 1-07 exists on the image generation server 1-20. However, for example, to improve availability or durability, a plurality of virtual machines can be provided. In this case, a load balancer can be configured to be located between the gateway 1-06 and the virtual machines. Then, one of the plurality of virtual machines is selected depending on a load status to cause the browser engine to operate, and the storage 1-09 is shared by the plurality of virtual machines.

The storage 1-09 included in the image generation server 1-20 stores non-volatile information about, for example, settings which become required for the above-mentioned browser engine to operate. Moreover, the storage 1-09 can be used as a cache region for user data, or can be used as a region for storing a rendering result.

The image forming apparatus 1-01 is an image processing apparatus (an information processing apparatus or a communication terminal) having, for example, the function of performing image formation (printing) on a sheet (paper) or the function of transmitting image data generated by scanning to an optional destination. The image forming apparatus 1-01 can be a printer in the form of any one of a multifunction peripheral (MFP) and a single-function peripheral (SFP). Moreover, the printing method of the image forming apparatus 1-01 can be any one of the electrophotographic method and the inkjet method. The image forming apparatus 1-01 in the present exemplary embodiment is characterized by using the image generation server 1-20 to enable viewing or displaying of web content existing on the Internet. Details thereof are described below.

The proxy server 1-04 is a server which monitors and restricts a communication performed between a network to which the image forming apparatus 1-01 belongs and the Internet. The proxy server 1-04 performs URL filtering (web filtering) for limiting an access to a web site.

### Virtual Machine

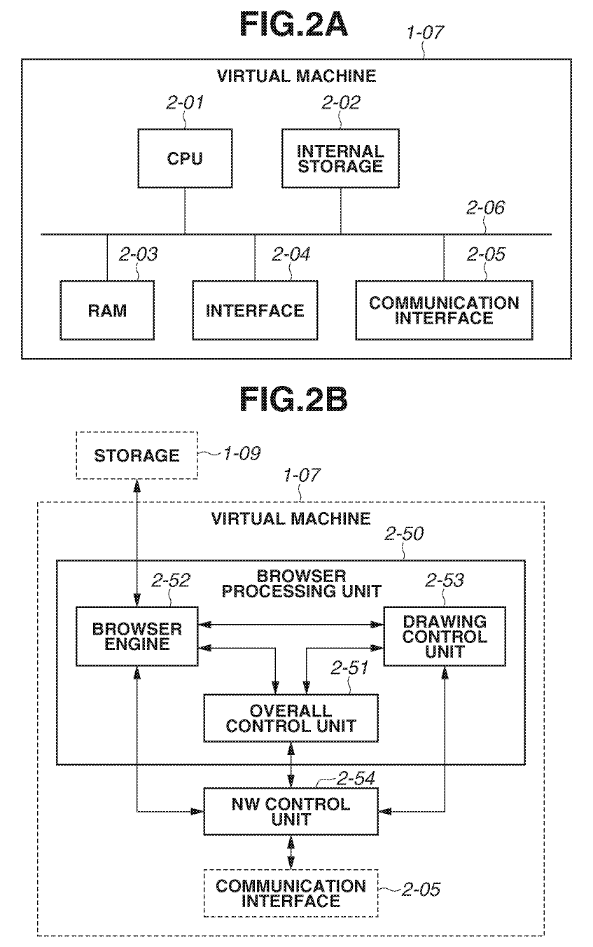

FIG. 2A is a block diagram illustrating a hardware configuration example of a virtual machine which operates in the cloud browser system.

The virtual machine 1-07 includes a central processing unit (CPU) 2-01, an internal storage 2-02, a random access memory (RAM) 2-03, an interface 2-04, and a communication interface 2-05. Each constituent element is interconnected via a bus 2-06 in such a way as to be able to communicate with each other.

The CPU 2-01 is a control unit which performs various control operations for the virtual machine 1-07. The CPU 2-01 performs various processing operations with use of computer programs and data stored in the internal storage 2-02. Thus, the CPU 2-01 not only performs operation control of the entire virtual machine 1-07 but also performs or controls various processing operations described below which are run on the virtual machine 1-07.

The internal storage 2-02 stores, for example, setting data for the virtual machine 1-07, a computer program or data involved in start-up of the virtual machine 1-07, and a computer program or data involved in a basic operation of the virtual machine 1-07.

The RAM 2-03 has areas for storing, for example, computer programs or data loaded from the internal storage 2-02 and data received from an external apparatus via the communication interface 2-05. Moreover, the RAM 2-03 has a work area which the CPU 2-01 uses to perform various processing operations. In this way, the RAM 2-03 is able to provide various areas (storage regions) as appropriate. In the present exemplary embodiment, a portion of areas of the RAM 2-03 is used as a cache region for user data described below.

The interface 2-04 is an interface including a display unit for displaying a processing result obtained by the CPU 2-01 with, for example, an image or characters and an operation unit which is operated by the user to perform various types of operation input. The display unit includes a liquid crystal screen or a touch panel screen. The operation unit includes a user interface such as a keyboard, a mouse, or a touch panel screen.

The communication interface 2-05 is an interface for performing data communication with an external apparatus. The communication interface 2-05 to be used includes, for example, a network interface compatible with Ethernet.

Furthermore, the configuration illustrated in FIG. 2A is merely an example of a configuration which is applicable to the virtual machine 1-07, and the applicable configuration is not intended to be limited to the configuration illustrated in FIG. 2A. For example, in the configuration illustrated in FIG. 2A, a memory device can be additionally connected to the bus 2-06. Examples of the memory device include a hard disk drive, a Universal Serial Bus (USB) memory, a magnetic card, an optical card, an integrated circuit (IC) card, a memory card, and a drive device.

Moreover, the virtual machine 1-07 is a machine which can be configured with what is called a virtual technique, so that it is possible to organize various resources constituting a computer system into logical units independent of a physical configuration. Thus, it is possible to configure the virtual machine 1-07 by integrating a plurality of resources or it is possible to divide one resource into a plurality of resources and configure one of the plurality of resources as the virtual machine 1-07. It is also possible to configure the virtual machine 1-07 by using at least some of a plurality of resources (able to be configured with a plurality of apparatuses) constituting cloud computing.

FIG. 2B is a diagram illustrating a software configuration of the virtual machine which operates in the cloud browser system. As illustrated in FIG. 2B, the virtual machine 1-07 includes, as software modules, a browser processing unit 2-50 and a network (NW) control unit 2-54.

The browser processing unit 2-50 is a module having charge of all-around processing involved in a browser which is executed on the cloud computing side, and is a principal portion of the cloud browser system 1-00. The browser processing unit 2-50 includes an overall control unit 2-51, a browser engine 2-52, and a drawing control unit 2-53.

The overall control unit 2-51 is a module which controls the entire browser processing unit 2-50, which operates on the virtual machine 1-07. When the user operates the image forming apparatus 1-01 to input a request for viewing of a web page in the web page server 1-05 which the user wants to view, the URL (address information) of the web page in the web page server 1-05 is transmitted from, for example, the image forming apparatus 1-01 to the image generation server 1-20 via the proxy server 1-04. The overall control unit 2-51 has the role of collectively receiving various requests transmitted from, for example, the image forming apparatus 1-01. Moreover, the overall control unit 2-51 also has the role of distributing the received requests to the browser engine 2-52 and the drawing control unit 2-53 described below as appropriate.

The browser engine 2-52 accesses the web page server 1-05 illustrated in FIG. 1 via the NW control unit 2-54 described below based on the URL passed from the overall control unit 2-51, and thus acquires web content from the web page server 1-05. Furthermore, the browser engine 2-52 includes the function of a HyperText Transfer Protocol (HTTP) client which is needed to acquire web content. Then, the browser engine 2-52 analyzes the acquired web content and then stores information about, for example, a cookie in a specific region on the RAM 2-03 illustrated in FIG. 2A as appropriate. Moreover, the browser engine 2-52 also has the function of referring to information about, for example, a cookie preliminarily stored in the specific region on the RAM 2-03. Additionally, upon completion of analysis of the web content, the browser engine 2-52 requests rendering processing from the drawing control unit 2-53 described below.

The drawing control unit 2-53 has the role of rendering web content based on a rendering request transmitted from the browser engine 2-52. Moreover, the drawing control unit 2-53 also has the role of transmitting, as a reply, a rendering result to, for example, the image forming apparatus 1-01, which is a source of request for the URL, via the NW control unit 2-54 described below. At this time, a configuration in which the storage 1-09 is used as a region for storing the rendering result and the drawing control unit 2-53 transfers image data stored in the storage 1-09 can be employed.

The NW control unit 2-54 is a module which relays communications in response to requests for access to external portions received from the overall control unit 2-51, the browser engine 2-52, and the drawing control unit 2-53. Examples of the external portions for the access requests include, for example, the image forming apparatus 1-01, the web page server 1-05, and the authentication site 1-10. Moreover, the NW control unit 2-54 also includes, for example, a protocol stack for HTTP communication which is needed for access to the web page server 1-05. When actually performing communications, the NW control unit 2-54 controls the communication interface 2-05 illustrated in FIG. 2A to implement communications with, for example, the image forming apparatus 1-01, the web page server 1-05, and the authentication site 1-10.

A rough flow performed by the virtual machine 1-07 is described as follows with reference to FIG. 2B.

When the user operates the image forming apparatus 1-01 to input a request for viewing a web page in the web page server 1-05 which the user wants to view, he URL of the web page in the web page server t1-05 is transmitted from, for example, the image forming apparatus 1-01 to the image generation server 1-20 via the proxy server 1-04. The overall control unit 2-51 receives the URL and then transfers the received URL to the browser engine 2-52. The browser engine 2-52, having received the URL, to acquire web content indicated by the URL, requests access to a web page in the web page server 1-05 indicated by the URL from the NW control unit 2-54. The NW control unit 2-54, having received the access request, controls the communication interface 2-05 and thus accesses the web page server 1-05 via the gateway 1-06 and the Internet 1-11. Then NW control when, nit 2-54 acquires web content from the web page server 1-05 and then transfers the acquired web content to the browser engine 2-52. The browser engine 2-52 uses user data, such as a cookie, cached on the RAM 2-03 as needed based on the transmitted web content, and thus performs analysis of the web content. Moreover, based on the analysis, the browser engine 2-52 requests the drawing control unit 2-53 to perform rendering of the web content. The drawing control unit 2-53, having received the request, performs rendering of the web content, and then communicates to the overall control unit 2-51 that rendering has been completed.The overall control unit 2-51 communicates, as a reply, to, for example, the image forming apparatus 1-01 serving as a URL requesting source via the NW control unit 2-54 that rendering has been completed. For example, the imageforming apparatus 1-01 having received such communication requests acquisition of a rendering result from the image generation server 1-20. The request ispassed to the overall control unit 2-51 via the NW control unit 2-54, and is then transferred to the drawing control unit 2-53 by the overall control unit 2-51. Then, the drawing control unit 2-53, having received such a request for acquisition of a rendering result, transmits, as a reply, a rendering result to, for example, the image forming apparatus 1-01 serving as a requesting source via the NW control unit 2-54. For example, the image forming apparatus 1-01 displays the rendering result. In this way, the user is enabled to view a desired content in the web page server 1-05.

### Image Forming Apparatus

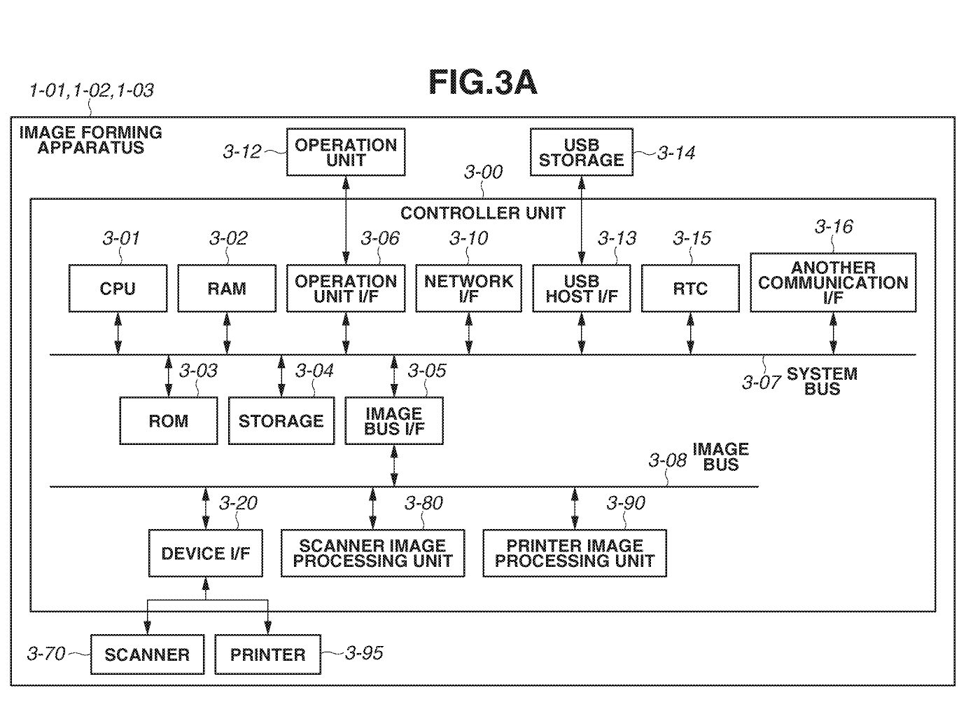

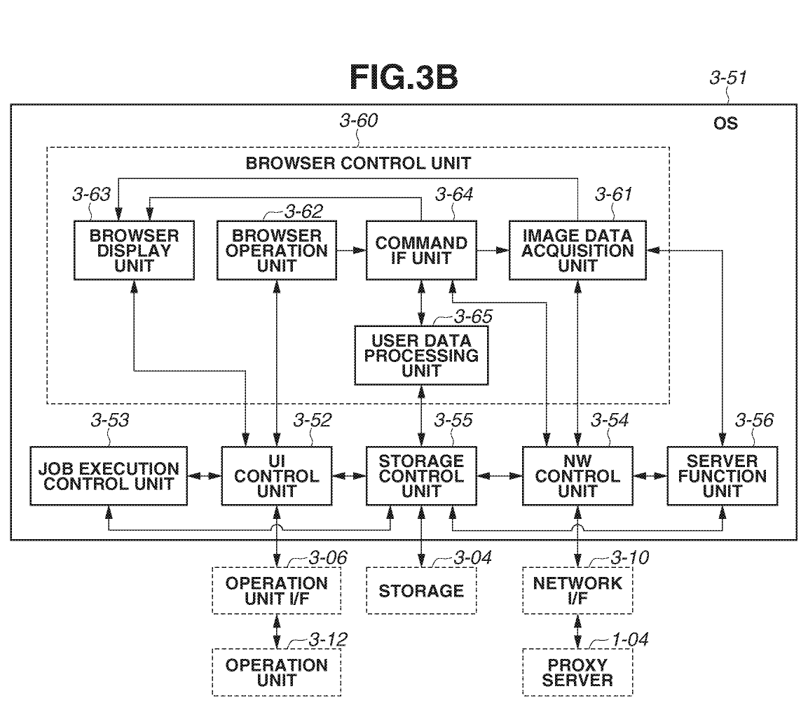

FIG. 3A is a diagram illustrating a hardware configuration of the image forming apparatus which operates in the cloud browser system. The image forming apparatus 1-01 includes a controller unit 3-00, an operation unit 3-12, a USB storage 3-14, a scanner 3-70, and a printer 3-95.

To the controller unit 3-00, not only the scanner 3-70, which is an image input device, and the printer 3-95, which is an image output device, are connected but also the operation unit 3-12 is connected.

The operation unit 3-12 is an operation unit which displays information to the user and receives inputting performed by the user.

The operation unit 3-12 is configured with, for example, a display, a touch panel sensor, and hardware keys.

The USB storage 3-14 is an external storage device which stores data. The USB storage 3-14 is detachably attached to a USB host interface (I/F) 3-13.

The scanner 3-70 is an image reading unit (an image reading device or an image input device) which reads an image from an original.

The printer 3-95 is an image forming unit (an image forming device or an image output device) which forms an image on a sheet (paper).

The controller unit 3-00 is a control unit including constituent elements configured to perform various control operations in the image forming apparatus 1-01. For example, the controller unit 3-00 performs control for implementing, for example, a copy function which prints and outputs image data read by the scanner 3-70 with the printer 3-95.

The controller unit 3-00 includes a CPU 3-01, a RAM 3-02, a read-only memory (ROM) 3-03, a storage 3-04, and an image bus I/F 3-05. These constituent elements are interconnected via a system bus 3-07 in such a way as to be able to communicate with each other.

Moreover, the controller unit 3-00 further includes an operation unit I/F 3-06, a network I/F 3-10, a USB host I/F 3-13, a real-time clock (RTC) 3-15, a device I/F 3-20, a scanner image processing unit 3-80, and a printer image processing unit 3-90. These constituent elements are interconnected via the image bus I/F 3-05 and an image bus 3-08 in such a way as to be able to communicate with each other.

The CPU 3-01 launches an operating system (OS) by a boot program stored in the ROM 3-03. The CPU 3-01 executes programs stored in the storage 3-04 on the OS, thus performing various processing operations.

The RAM 3-02 is used as a work area for the CPU 3-01. The RAM 3-02 not only provides the work area but also provides an image memory area for temporarily storing image data.

The storage 3-04 stores programs and data. Examples of the storage 3-04 to be used include a hard disk drive (HDD), a solid state drive (SSD), or an embedded Multi Media Card (eMMC).

The ROM 3-03, the RAM 3-02, the operation unit I/F 3-06, and the network I/F 3-10 are connected to the CPU 3-01 via the system bus 3-07. Moreover, the USB host I/F 3-13 and the image bus I/F 3-05 are connected to the CPU 3-01 via the system bus 3-07.

The operation unit I/F 3-06 is an interface with the operation unit 3-12, and outputs, to the operation unit 3-12, image data to be displayed on the operation unit 3-12. Moreover, the operation unit I/F 3-06 sends out, to the CPU 3-01, information input by the user via the operation unit 3-12.

The network I/F 3-10 is an interface for connecting the image forming apparatus to a local area network (LAN).

The USB host I/F 3-13 is an interface unit which communicates with the USB storage 3-14. The USB host I/F 3-13 also functions as an output unit configured to cause data stored in the storage 3-04 to be stored in the USB storage 3-14. Moreover, the USB host I/F 3-13 receives, as an input, data stored in the USB storage 3-14 and transfer the input data to the CPU 3-01.

The USB storage 3-14 is an external storage device which stores data, and is detachably attached to the USB host I/F 3-13. The USB host I/F 3-13 allows a plurality of USB devices including the USB storage 3-14 to be connected thereto.

The RTC 3-15 controls current time. Time information which is controlled by the RTC 3-15 is used for, for example, recording of a job input time.

Another communication I/F 3-16 is an interface which performs intercommunication between the image forming apparatus and another device under a communication standard such as Bluetooth^{®} or Near-field communication (NFC).

The image bus I/F 3-05 is a bus bridge configured to connect the system bus 3-07 and the image bus 3-08 for transferring image data at high speed to each other and to convert a data format.

The image bus 3-08 is configured with, for example, a Peripheral Component Interconnect (PCI) bus or an Institute of Electrical and Electronics Engineers (IEEE) 3-394 bus. The device I/F 3-20, the scanner image processing unit 3-80, and the printer image processing unit 3-90 are provided on the image bus 3-08.

The scanner 3-70 and the printer 3-95 are connected to the device I/F 3-20, and the device I/F 3-20 performs conversion between synchronous system and asynchronous system of image data.

The scanner image processing unit 3-80 performs correction, modification, and editing on input image data.

The printer image processing unit 3-90 performs, for example, correction or resolution conversion corresponding to the printer 3-95 with respect to print output image data.

FIG. 3B is a diagram illustrating a software configuration of the image forming apparatus which operates in the cloud browser system.

Each unit illustrated by a solid line in FIG. 3B is a software module which is implemented by the CPU 3-01 executing a main program loaded onto the RAM 3-02.

In the main program, execution of each module thereof described below is managed and controlled by an operating system (OS) 3-51.

A user interface (UI) control unit 3-52 displays a screen on the operation unit 3-12 and thus receives an operation performed by the user via the operation unit I/F 3-06. Moreover, the UI control unit 3-52 has the function of sending a notification to another module and controlling screen updating upon receiving a drawing instruction from another module.

A job execution control unit 3-53 is a module which controls job processing for, for example, copying, scanning, or printing upon receiving a job execution instruction from the UI control unit 3-52.

A network (NW) control unit 3-54 controls the network I/F 3-10 upon receiving a communication request from another module, thus controlling communication with an external apparatus. Moreover, upon receiving a notification from an external apparatus, the NW control unit 3-54 notifies another module of the content of the received notification.

A storage control unit 3-55 performs recordkeeping of setting information or job information recorded on the storage 3-04. Each module located in the hierarchical level of the OS 3-51 accesses the storage control unit 3-55 and performs reference and setting of a setting value.

A server function unit 3-56 controls a web server function. For example, the server function unit 3-56 allows an external apparatus to access a web page in the image forming apparatus via the NW control unit 3-54 and thus performing reference and setting of, for example, setting information recorded on the storage 04.3

A browser control unit 3-60 is one submodule included in the OS 3-51, and performs control specific to a cloud browser described below. Moreover, the number of submodules included in the OS 3-51 is optional. As illustrated in FIG. 3B, the browser control unit 3-60 includes at least an image data acquisition unit 3-61, a browser operation unit 3-62, a browser display unit 3-63, a command interface (IF) unit 3-64, and a user data processing unit 3-65.

The browser operation unit 3-62 has the function of, upon receiving a notification of an operation performed by the user from the UI control unit 3-52, notifying the command IF unit 3-64 of the content of the user operation.

The command IF unit 3-64 has a role of comprehensively controlling the entire browser control unit 3-60. Moreover, the command IF unit 3-64 receives a notification from the browser operation unit 3-62 and requests a communication with the image generation server 1-20 via the NW control unit 3-54. The request for communication at that time may, in some cases, include information about the received notification. The information about the received notification includes user operations such as text input, link pressing, scroll, and zoom. For example, text input includes a URL.

At the time of link pressing, the information about the received notification includes coordinates of pressing on the operation unit 3-12, and, at the time of scroll and zoom, the information about the received notification includes, for example, a character string associated with each of them. Additionally, the command IF unit 3-64 receives, via the NW control unit 3-54, a notification transmitted from the image generation server 1-20. The command IF unit 3-64 processes the content of the received notification and notifies the image data acquisition unit 3-61 or the browser display unit 3-63.

The image data acquisition unit 3-61 receives a notification of the completion of a rendering result from the command IF unit 3-64. Upon receiving the notification, the image data acquisition unit 3-61 requests acquisition of an image from the image generation server 1-20. As mentioned above in FIG. 2B, the image acquisition request is transferred to the drawing control unit 2-53, which operates on the virtual machine 1-07 constituting the image generation server 201-, an image is sent out from the drawing control unit 2-53, and a rendering result is transmitted to the image data acquisition unit 3-61 as a reply. The image data acquisition unit 3-61, having received the rendering result, transfers an image being the rendering result to the browser display unit 3-63.

The browser display unit 3-63 receives an image from the image data acquisition unit 3-61 and instructs the UI control unit 3-52 to perform drawing of the image. Alternatively, the browser display unit 3-63 receives a notification from the command IF unit 3-64 and instructs the UI control unit 3-52 to display a message corresponding to the notification.

The user data processing unit 3-65 cooperates with the storage control unit 3-55 and performs reading and writing of user data between a specific region of the storage 3-04 and the user data processing unit 3-65. At the time of start-up of the browser control unit 3-60, the user data processing unit 3-65 takes charge of synchronous processing of user data between a cache on the image generation server 1-20 and a storage on, for example, the image forming apparatus 1-01. Moreover, the user data processing unit 3-65 performs backup processing of user data as appropriate in conjunction with access to a web page.

### User Terminal

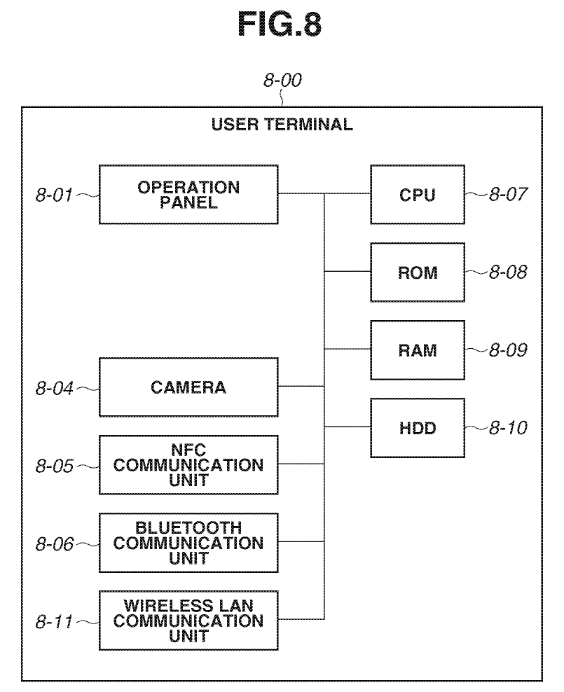

FIG. 8 is a diagram illustrating an example of a hardware configuration of the user terminal 8-00. Furthermore, the user terminal 8-00 in the present exemplary embodiment is assumed to be a client terminal which is an apparatus such as a smartphone or a personal computer (PC).

A CPU 8-07 reads out a control program stored in a ROM 8-08 and performs various processing operations for controlling the operation of the user terminal 8-00. The ROM 8-08 stores the control program. A RAM 8-09 is used as a temporary storage region such as a main memory or a work area for the CPU 8-07. A hard disk drive (HDD) 8-10 stores various pieces of data such as photographs and electronic documents.

An operation panel 8-01 has a touch panel function capable of detecting a touch operation of the user as an input instruction, and displays various screens which an OS or an e-mail send application provides. The user inputs a touch operation to the operation panel 8-01, thus being able to input a desired operation instruction to the user terminal 8-00. Furthermore, the user terminal 8-00 is equipped with hardware keys (not illustrated), so that the user can use the hardware keys to input an operation instruction to the user terminal 8-00. Moreover, the user is allowed to connect, for example, a keyboard or a mouse to the user terminal 8-00 and perform a desired operation. A camera 8-04 performs image capturing in response to an image capturing instruction issued by the user. A photograph captured by the camera 8-04 is then stored in a predetermined region of the HDD 8-10. Moreover, the user terminal 8-00 is able to acquire information from a QR code^{®} (quick-response code) (two-dimensional code) read by the camera 8-04 with use of a program capable of analyzing a QR code. The user terminal 8-00 is able to perform transmission and reception of data with various peripheral apparatuses including the image forming apparatuses 1-01, 1-02, and 1-03 via an NFC communication unit 8-05, a Bluetooth communication unit 8-06, or a wireless LAN communication unit 8-11. The Bluetooth communication unit 8-06 of the user terminal 8-00 can be compatible with Bluetooth Low Energy.

### Method for Utilization of Cloud Browser System

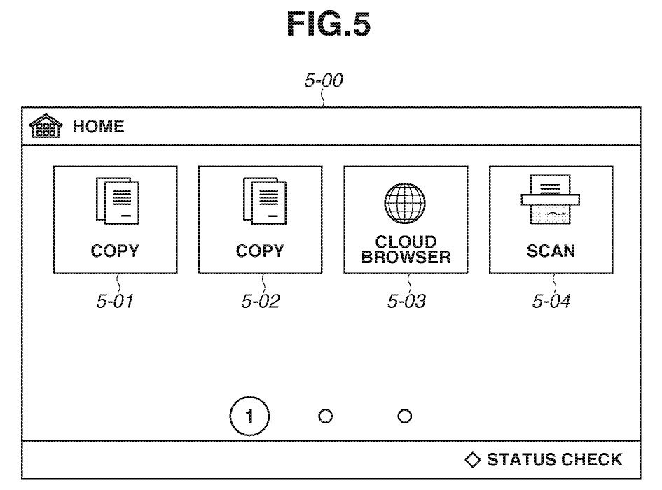

FIG. 5 is a diagram illustrating an example of a home screen which is displayed on the image forming apparatus 1-01.

The home screen is generated by a program configuring the UI control unit 3-52 illustrated in FIG. 3B being executed by the CPU 3-01, and is displayed on the operation unit 3-12. Each of a button 5-01 and a button 5-02 is an example of a button involved in the copy function. A button 5-03 is an example of a button involved in a cloud browser in the present exemplary embodiment. A button 5-04 is an example of a button involved in the scan function. In response to any one of the buttons 5-01 to the button 5-04 being selected, a function associated with the selected button is executed. For example, in response to the button 5-03 being selected, the cloud browser function is executed.

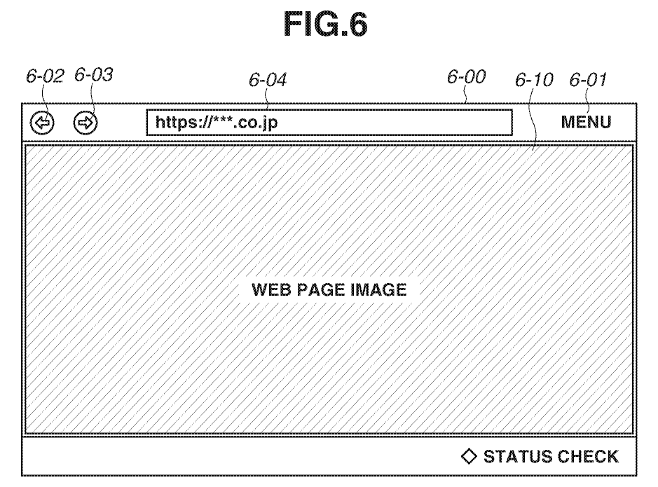

FIG. 6 is a diagram illustrating a configuration of a screen which is generated in the cloud browser system in the present exemplary embodiment. A cloud browser screen 6-00 is displayed on the operation unit 3-12.

A menu 6-01 is a button for referring to favorites or a history, which is one element of the browser function. When the user selects the menu 6-01, for example, a cloud browser menu screen is displayed, so that the user can view web pages which the user registered in a bookmark or a history of web pages which the user previously visited. A button 6-02 is a button for moving backward a screen transition or user operation to a previous state once, which is one element of the browser function. When the button 6-02 is pressed, a rendering result obtained in a case where the operation has been moved backward to a previous state once is displayed. A button 6-03 is a button for moving forward a screen transition or user operation to a succeeding state once, which is one element of the browser function. The button 6-03 is able to be selected only in a case where the user operation is able to be moved forward once, and, when the button 6-03 has been pressed, a rendering result, which is a state to which the user operation has been moved forward once, is displayed. A character string display area 6-04 is an example of an area showing a URL or title of a web page which is being displayed. When the user has selected a link within a rendering result 6-10, a request for rendering of a web page designated by the link is transmitted to the virtual machine 1-07. An image obtained by rendering performed by the virtual machine 1-07 is displayed as the rendering result 6-10. The rendering result is drawn by the image data acquisition unit 3-61 acquiring image data from the virtual machine 1-07 and the browser display unit 3-63 instructing the UI control unit 3-52 to perform drawing.

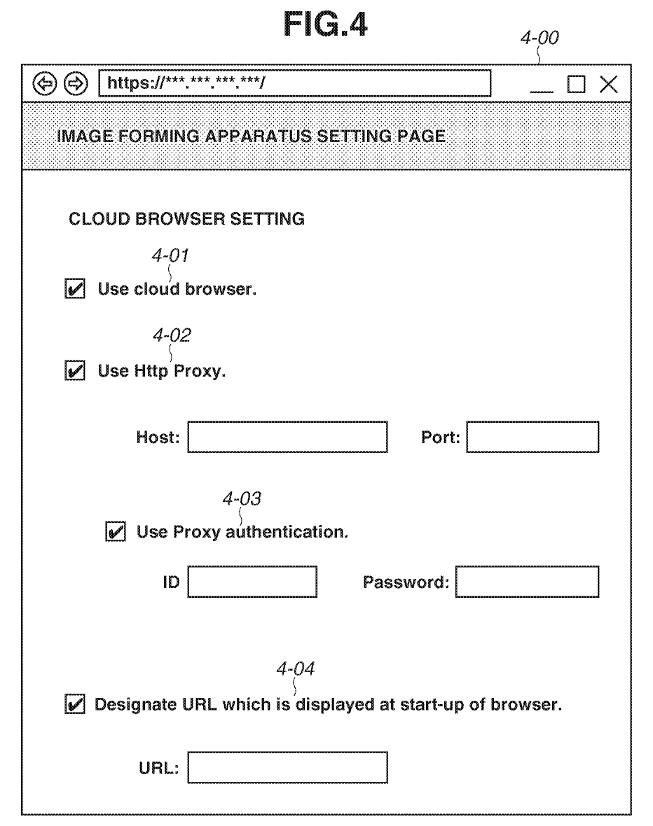

FIG. 4 is a diagram illustrating an example of a setting screen which operates in the cloud browser system in the present exemplary embodiment. The setting screen 4-00 is displayed on the operation unit 3-12 of the image forming apparatus 1-01.

Moreover, in a case where the image forming apparatus 1-01 has the server function, the setting screen 4-00 is displayed even by the user accessing a specific URL via a web browser connected by a network line.

In the above-mentioned cloud browser function, settings are able to be changed by operating the setting screen 4-00. In the case of using the cloud browser function, the user checks a cloud browser function switching check box 4-01. In response to the check box 4-01 being checked, the button 5-03 is displayed. Moreover, a check box 4-02 and subsequent check boxes become able to be edited. In a case where a proxy is being used for web access, the user checks the proxy use switching check box 4-02 and then sets host and port information about the proxy. Additionally, in a case where the proxy needs authentication, the user checks a proxy authentication check box 4-03 and then designates proxy authentication information (an identifier (ID) and a password). The user checks a start-up URL designating check box 4-04 and then designates a URL, thus being able to designate a URL which is first displayed at the time of execution of the cloud browser function.

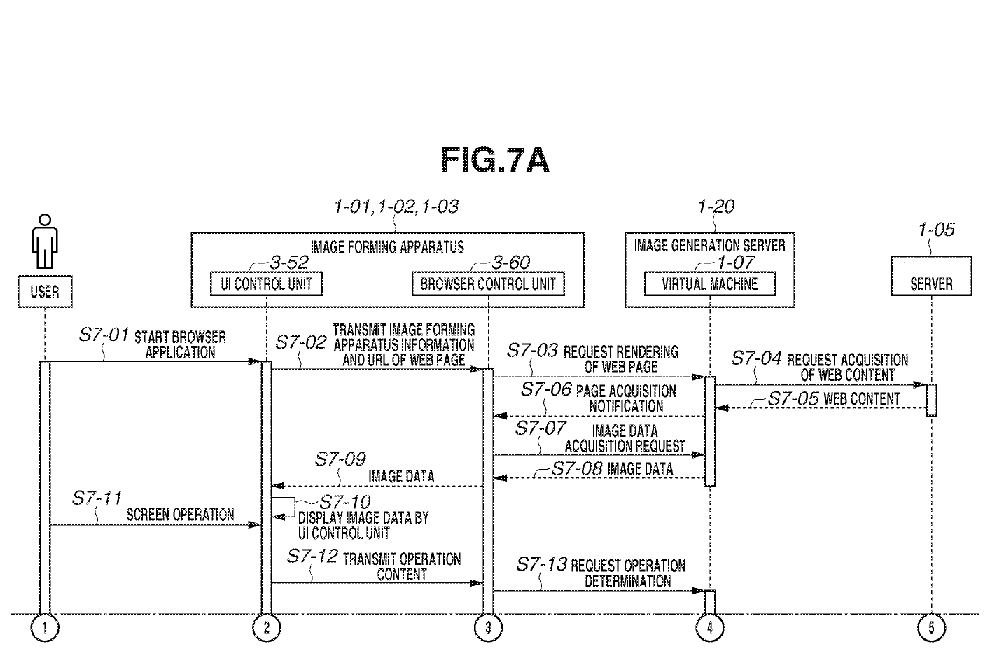

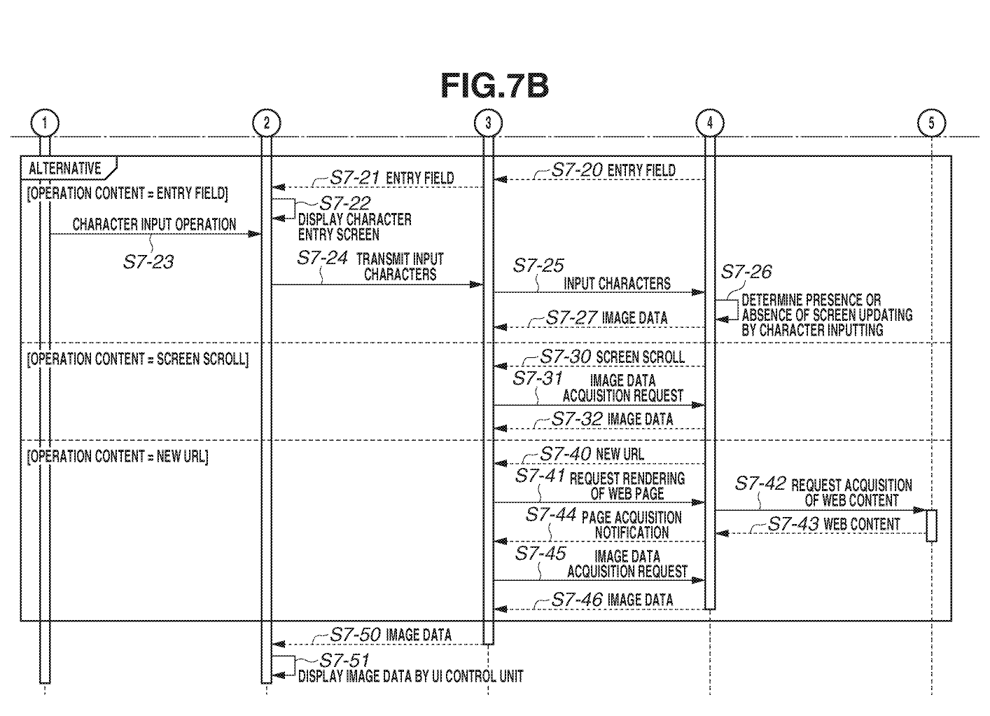

FIGS. 7A and 7B are sequence diagrams illustrating a procedure of basic processing for using the cloud browser system.

In step S7-01, the user presses the button 5-03 in the home screen 5-00, which is being displayed on the operation unit 3-12 of the image forming apparatus 1-01. In step S7-02, the UI control unit 3-52, having received such an instruction, starts up the browser control unit 3-60 via the OS 3-51. At this time, the URL of a web page and information about a display environment for screens included in the image forming apparatus 1-01 are transmitted to the browser control unit 3-60.

In step S7-03, the browser control unit 3-60, having received these pieces of information, makes a request for rendering of a web page to the virtual machine 1-07.

In step S7-04, the virtual machine 1-07 makes a request for acquisition of web content to the web page server 1-05.

In step S7-05, the web page server 1-05 provides web content to the virtual machine 1-07.

In step S7-06, the browser control unit 3-60 receives a page acquisition notification from the virtual machine 1-07.

In step S7-07, the browser control unit 3-60 makes a request for acquisition of image data conforming to the display environment of screens of the image forming apparatus 1-01.

In step S7-08, the virtual machine 1-07 transmits image data to the browser control unit 3-60.

In step S7-09, the browser control unit 3-60 transmits the image data to the UI control unit 3-52.

In step S7-10, the UI control unit 3-52 displays the image data on the operation unit 3-12.

In step S7-11, the user performs an additional screen operation on the browser screen displayed on the operation unit 3-12.

In step S7-12, the UI control unit 3-52 transmits an operation method (for example, touch or long tap) and operation coordinates as an operation content to the browser control unit 3-60.

In step S7-13, the browser control unit 3-60, having received the operation content, requests the virtual machine 1-07 to determine what operation the operation performed by the user is.

In a case where the operation content has been an entry field, in steps S7-20 and S7-21, the browser control unit 3-60 receives a notification from the virtual machine 1-07 and then notifies the UI control unit 3-52 that the operation content is an entry field. At this time, if a restriction exists on input characters, the browser control unit 3-60 can transmit the content of the restriction to the UI control unit 3-52.

In step S7-22, the UI control unit 3-52, having received the notification indicating that the operation content is an entry field, displays a character entry screen on the operation unit 3-12. In step S7-23, the user performs a character input operation.

In steps S7-24 and S7-25, the browser control unit 3-60 receives the input characters from the UI control unit 3-52 and then transmits the input characters to the virtual machine 1-07.

In step S7-26, the virtual machine 1-07 determines whether there is screen updating caused by character inputting. The virtual machine 1-07 performs access to the web page server 1-05 and acquisition of web content as needed. For example, in the case of a page in which, when character inputting has been performed in a search box, a suggestion is displayed, screen updating is needed, so that the virtual machine 1-07 performs acquisition of web content. On the other hand, in the case of a page in which there is no change in the screen until a search button is pressed, the virtual machine 1-07 performs changing of only a character entry field portion. In step S7-27, the browser control unit 3-60 receives image data serving as an updated result from the virtual machine 1-07, and, in step S7-50, the browser control unit 3-60 transmits the image data to the UI control unit 3-52. In step S7-51, the UI control unit 3-52 displays the image data serving as an updated result on the operation unit 3-12. In step S7-42, the virtual machine 1-07 makes a request for acquisition of web content to the web page server 1-05, and, in step S7-43, the virtual machine 1-07 acquires web content from the web page server 1-05. Then, the virtual machine 1-07 performs rendering of the acquired web content.

In step S7-30, the browser control unit 3-60 receives, from the virtual machine 1-07, a notification indicating that the operation content is screen scroll, and, in step S7-31, the browser control unit 3-60 requests image data serving as a scroll destination from the virtual machine 1-07. The virtual machine 1-07 performs access to the web page server 1-05 or acquisition of web content as needed. For example, in the case of a page in which a screen content changes according to screen scroll, screen updating is needed, so that the virtual machine 1-07 performs acquisition of web content.

In steps S7-32, S7-50, and S7-51, the UI control unit 3-52 displays image data obtained after scroll on the operation unit 3-12.

In step S7-40, the browser control unit 3-60 receives, from the virtual machine 1-07, a notification indicating that the operation content is a new URL, and, in step S7-41, the browser control unit 3-60 transmits the new URL to the virtual machine 1-07 and makes a request for rendering of web content to the virtual machine 1-07.

In step S7-44, the virtual machine 1-07 transmits a notification of acquisition of web content to the browser control unit 3-60.

In step S7-45, the browser control unit 3-60 transmits a request for acquisition of image data to the virtual machine 1-07, and, in step S7-46, the browser control unit 3-60 acquires image data from the virtual machine 1-07.

In step S7-50, the browser control unit 3-60 transmits image data serving as the acquired new page to the UI control unit 3-52.

In step S7-51, the UI control unit 3-52 displays the image data on the operation unit 3-12.

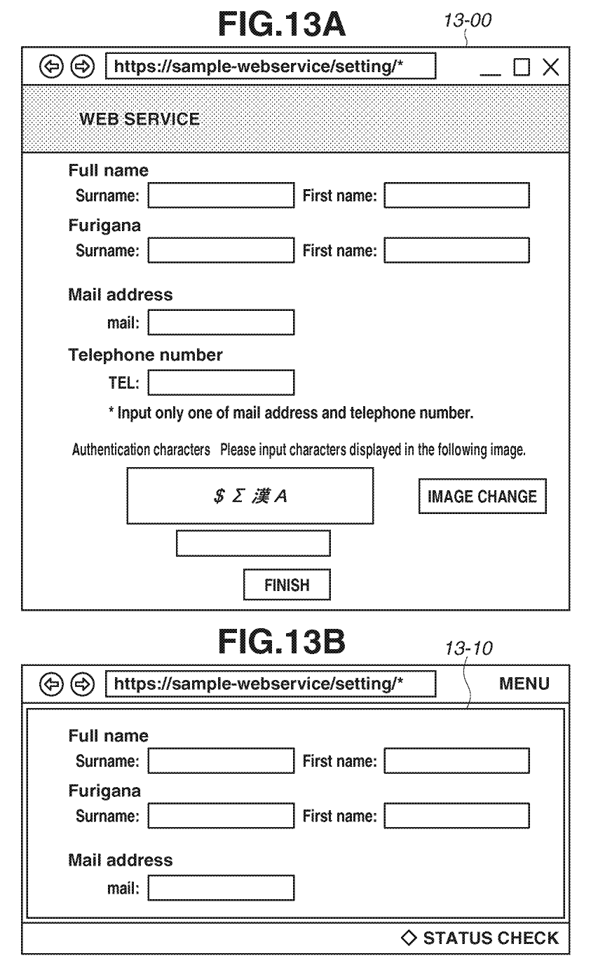

FIGS. 13A and 13B are diagrams each illustrating an example of a web page for performing setting of a web service.

The screen 13-00 illustrated in FIG. 13A is an example of a web page screen which the user has accessed with use of the browser of a user terminal such as a smartphone or a PC. In this example, such a form that the user inputs the user’s full name, furigana, mail address or telephone number, and authentication characters and then finishes setting is employed.

The screen illustrated in FIG. 13B is an example of a web page screen 13-10 which the user has accessed with use of a cloud browser application which is displayed on the operation unit 3-12 of the image forming apparatus 1-01. The screen illustrated in FIG. 13B is a display screen for the same web page as that illustrated in FIG. 13A. A display mounted to the image forming apparatus 1-01 is generally lower in display capability than a display included in a general-purpose information processing apparatus such as a user terminal. Therefore, to display image data, it is necessary to view the entire page by scrolling the page with a touch operation.

### Operation on User Terminal in Cloud Browser System

In view of the above-mentioned situation, in the present exemplary embodiment, the user terminal 8-00, which is superior in display capability, is used to enable viewing the entire page.

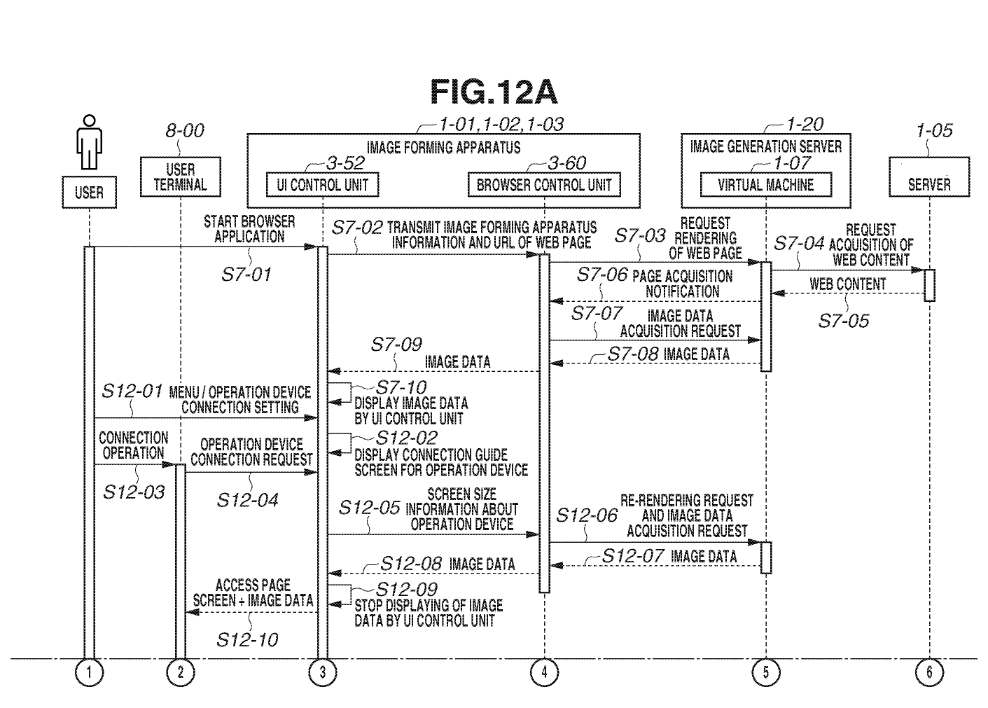

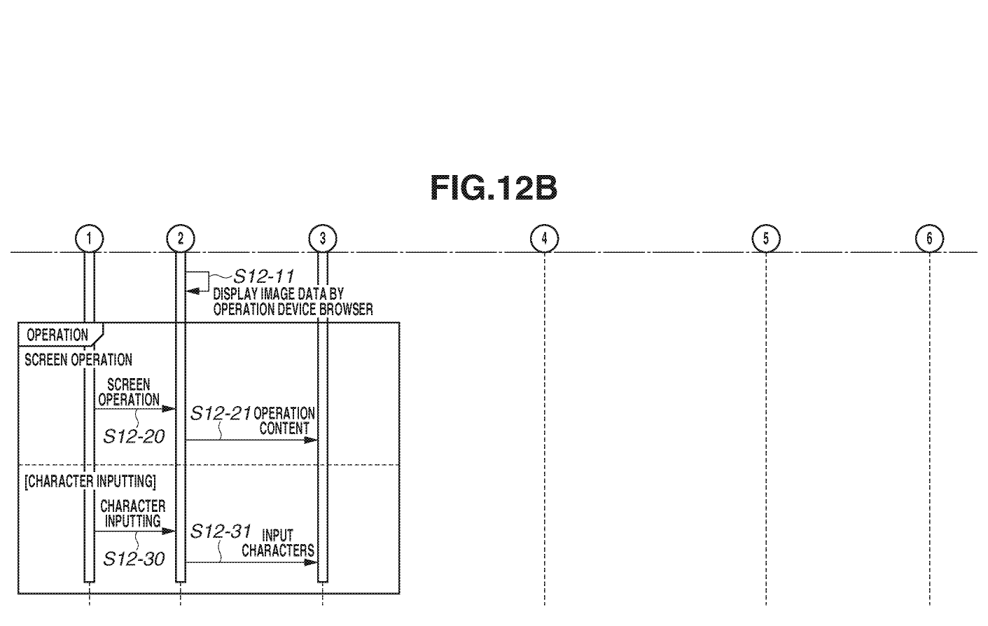

FIGS. 12A and 12B are sequence diagrams illustrating a procedure of processing which the cloud browser system performs at the time of connection of an operation device in the present exemplary embodiment. The operation device in the present sequence diagram is assumed to be the user terminal 8-00. The procedure starting with start-up of the browser control unit 3-60 by the user until displaying of image data in the operation unit 3-12 (steps S7-01 to S7-10) is similar to that described with reference to FIG. 7A, and is, therefore, omitted from description.

When, in step S12-01, the user performs an operation of pressing the menu 6-01 and a “connection of operation device” button 9-03 in this order, then in step S12-02, the image forming apparatus 1-01 displays a “connection of operation device” guide screen 9-10.

In step S12-03, the user performs an operation of connecting the user terminal 8-00 as a connection device to the image forming apparatus 1-01 based on the displayed “connection of operation device” guide screen 9-10.

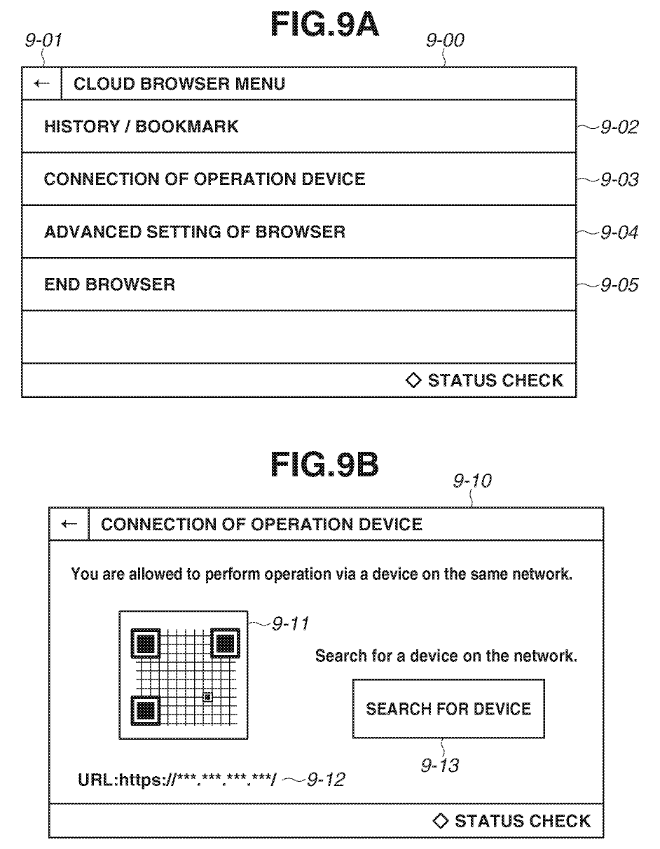

FIG. 9A is a diagram illustrating an example of a menu screen in the cloud browser application in the present exemplary embodiment. The cloud browser menu screen 9-00 illustrated in FIG. 9A is an example of a screen to which the cloud browser screen 6-00 transitions when the menu 6-01 has been selected. When a back button 9-01 is pressed, the cloud browser menu screen 9-00 returns to the cloud browser screen 6-00. When an “end browser” button 9-05 is pressed, the cloud browser menu screen 9-00 returns to the home screen 5-00.

When a “history / bookmark” button 9-02 is pressed, a screen enabling viewing page information which the user previously accessed with the cloud browser or information about pages stored in the bookmark is displayed. When an “advanced setting of browser” button 9-04 is pressed, a reference screen for advanced settings concerning the cloud browser connection or the connection status is displayed. These buttons are not essential for the present exemplary embodiment and, therefore, can be omitted.

The connection guide screen 9-10 for the user terminal 8-00 illustrated in FIG. 9B is an example of a screen to which the cloud browser menu screen 9-00 transitions when the connection button 9-03 for the user terminal 8-00 has been selected. The menu hierarchy or screen configuration does not need to be as illustrated. The connection guide screen 9-10 for the user terminal 8-00 is used to connect the image forming apparatus 1-01 and the user terminal 8-00 on the same network to each other. As information used for connection, a two-dimensional code 9-11 (QR code) and a URL 9-12 are displayed. Image capturing of the two-dimensional code 9-11 or manually inputting of the URL 9-12 by the user enables the user to access a web page which the image forming apparatus 1-01 provides. Alternatively, a method in which, when a “search for device” button 9-13 is pressed, a device to which the image forming apparatus 1-01 is able to connect within an intranet is searched for can be used. Additionally, a short-range wireless communication such as NFC or Bluetooth can be used to input address information from the image forming apparatus 1-01 to the user terminal 8-00. When any method is used to access the image forming apparatus 1-01, the user terminal 8-00 becomes able to operate the browser control unit 3-60. Furthermore, while, here, an example in which QR code, NFC, or Bluetooth is used to exchange address information has been described, other information can be exchanged in addition to address information. For example, with use of QR code, NFC, or Bluetooth, network information about the image forming apparatus 1-01 (the service set identifier (SSID) of an access point for wireless LAN infrastructure connection, direct connection information for direct connection, or an Internet Protocol (IP) address) can be exchanged. The user terminal 8-00 is able to establish a network environment capable of connecting to the image forming apparatus 1-01 with use of such network information.

In step S12-04, the UI control unit 3-52 receives an operation device connection request via the server function of the image forming apparatus 1-01. In step S12-05, when the user terminal 8-00 has been connected, the UI control unit 3-52 transmits, to the browser control unit 3-60, screen size information (display size information) which is used for web browsing in the user terminal 8-00. In step S12-06, the browser control unit 3-60 makes a re-rendering request to the virtual machine 1-07 based on the received screen size information. In step S12-07, the virtual machine 1-07 transmits the rendered image data to the browser control unit 3-60. In step S12-08, the browser control unit 3-60 transmits the rendered image data to the UI control unit 3-52. During connection of the user terminal 8-00 (when a web page is being displayed for viewing by the user terminal 8-00), the content of the web page can be displayed or does not need to be displayed on the operation unit 3-12 of the image forming apparatus 1-01.

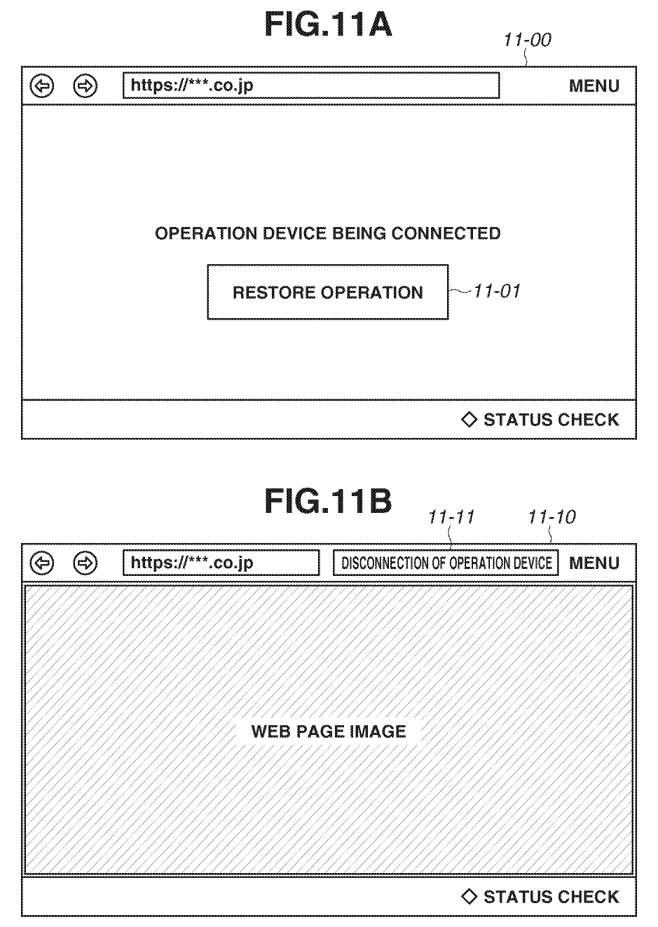

FIGS. 11A and 11B are diagrams each illustrating an example of a screen of the image forming apparatus when the user terminal is connecting to the image forming apparatus in the present exemplary embodiment. The content display of a web page on the operation unit 3-12 of the image forming apparatus when the user terminal is connecting to the image forming apparatus can be in the specified form or can be in the form switchable by advanced setting.

The screen illustrated in FIG. 11A is a screen 11-00 which is displayed in a case where, when the operation device is connecting to the image forming apparatus, the content of a web page accessed with the cloud browser is not displayed on the operation unit 3-12 of the image forming apparatus. When a “restore operation” button 11-01 is pressed, a communication of image data and an operation content of the cloud browser between the image forming apparatus and the operation device is stopped (halted), and the screen 11-00 returns to the cloud browser screen 6-00, which displays a web page screen being displayed.

The screen illustrated in FIG. 11B is a screen 11-10 which is displayed in a case where, even when the operation device is connecting to the image forming apparatus, the content of a web page accessed with the cloud browser is displayed on the operation unit 3-12 of the image forming apparatus. When a “disconnection of operation device” button 11-11 is pressed, a communication of image data and an operation content of the cloud browser between the image forming apparatus and the operation device is stopped, displaying of the “disconnection of operation device” button 11-11 is halted, and the screen 11-10 returns to the cloud browser screen 6-00, which displays a web page screen.

In the case of setting for performing displaying, the UI control unit 3-52 performs displaying of a web page on the operation unit 3-12. In the case of setting for not performing displaying, in step S12-09, the UI control unit 3-52 stops displaying of image data on the operation unit 3-12.

In step S12-10, the UI control unit 3-52 provides, to the user terminal 8-00, new web content in which image data of the cloud browser screen has been incorporated into a page for operation device access, via the server function of the image forming apparatus 1-01.

In step S12-11, the user terminal 8-00, having received the re-configured web content, displays a page screen 10-00 including the cloud browser screen.

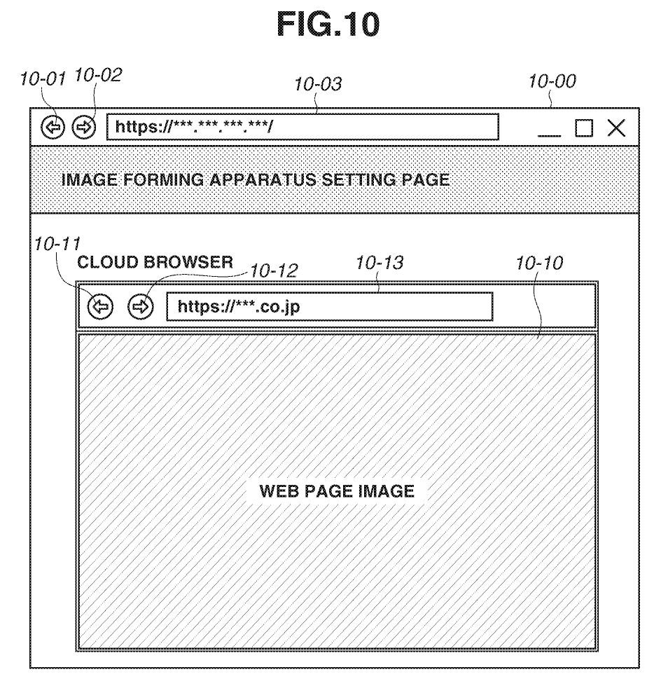

FIG. 10 is a diagram illustrating an example of a screen which is displayed when the user terminal has accessed the cloud browser system via the image forming apparatus in the present exemplary embodiment. The present screen 10-00 is a screen which is displayed when the user terminal has accessed a specific URL via a web browser connected with a network line by the server function of the image forming apparatus 1-01, as with the setting screen 4-00, which operates in the cloud browser system. A backward button 10-01, a forward button 10-02, and a URL field 10-03 are used to operate the web browser of the user terminal 8-00. The button configuration depends on a browser and is not limited to the illustrated configuration. On the other hand, a web page image 10-10 is an image generated by the virtual machine 1-07 of the cloud browser system and transmitted to the image forming apparatus 1-01. A backward button 10-11, a forward button 10-12, and a URL field 10-13 are used to operate a web page which the cloud browser system accesses.

After that, in step S12-20, the user performs an operation on the cloud browser via the user terminal 8-00. The screen operation (step S7-11) which has been performed on the operation unit 3-12 of the image forming apparatus 1-01 is performed in a similar way on the browser of the user terminal 8-00. In step S12-21, the user terminal 8-00 transmits the operation content to the UI control unit 3-52. The UI control unit 3-52 transmits the operation content of the user terminal 8-00 to the browser control unit 3-60.

The subsequent procedure performed between the UI control unit 3-52, the browser control unit 3-60, and the web page server 1-05 is performed in a manner similar to the procedure in step S7-12 illustrated in FIG. 7A and subsequent steps. In step S12-30, the character input operation (step S7-23), which has been performed on the operation unit 3-12 of the image forming apparatus 1-01, is performed by a character input system, such as an input method editor (IME), of the user terminal 8-00. In step S12-31, the user terminal 8-00 transmits input characters (input information) to the UI control unit 3-52. The subsequent procedure performed between the UI control unit 3-52, the browser control unit 3-60, and the web page server 1-05 is performed in a manner similar to the procedure in step S7-24 illustrated in FIG. 7B and subsequent steps.

### Control

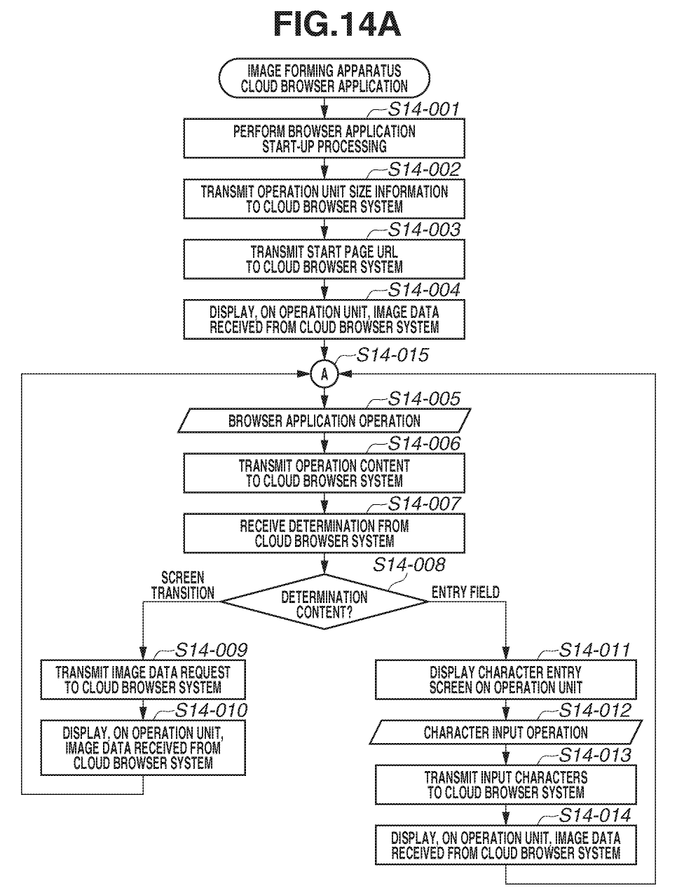

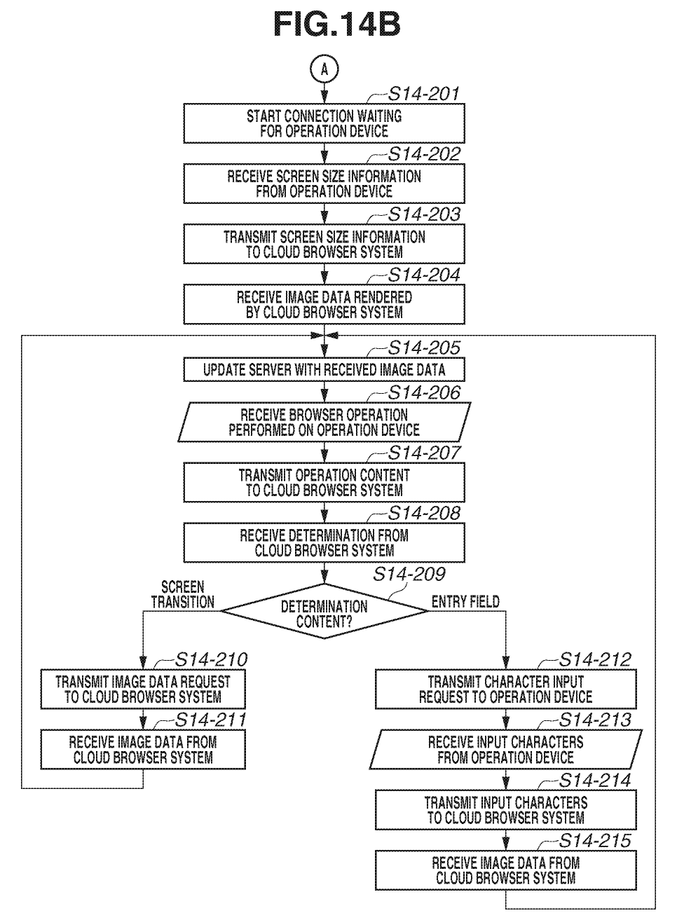

FIGS. 14A and 14B are flowcharts of processing which the image forming apparatus performs when the user terminal is connecting to the image forming apparatus in the present exemplary embodiment.

The processing illustrated in FIGS. 14A and 14B is a part of a program constituting the browser control unit 3-60 and a part of a program constituting the server function unit 3-56 illustrated in FIG. 3B and is executed by the CPU 3-01 illustrated in FIG. 3A.

Processing for a usual operation of the cloud browser application is described with reference to FIG. 14A.

First, in step S14-001, the CPU 3-01 performs start-up processing of the browser application. In steps S14-002 and S14-003, concurrently with start-up, the CPU 3-01 transmits, to the cloud browser system 1-00, size information about the operation unit 3-12 of the image forming apparatus and the URL of a start page. Next, in step S14-004, the CPU 3-01 displays image data received from the cloud browser system 1-00 on the operation unit 3-12.

Next, in step S14-005, the CPU 3-01 receives an operation performed by the user on the displayed web page image, and, in step S14-006, the CPU 3-01 transmits an operation content input to the operation unit 3-12 to the cloud browser system 1-00. Next, in step S14-007, the CPU 3-01 receives a determination of the operation content, which is a response from the cloud browser system 1-00.

Next, in step S14-008, the CPU 3-01 performs determination based on the received determination content. If the determination content is “screen transition” such as page updating by a new URL or screen scroll (SCREEN TRANSITION in step S14-008), then in step S14-009, the CPU 3-01 transmits an image data request to the cloud browser system 1-00. In step S14-010, the CPU 3-01 displays image data received from the cloud browser system 1-00 on the operation unit 3-12.

If the received operation content is “entry field” (ENTRY FIELD in step S14-008), then in step S14-011, the CPU 3-01 displays a character entry screen on the operation unit 3-12, and, in step S14-012, the CPU 3-01 receives an input operation performed by the user on the displayed character entry screen. Next, in step S14-013, the CPU 3-01 transmits input characters to the cloud browser system 1-00, and, in step S14-014, the CPU 3-01 displays image data received from the cloud browser system 1-00 on the operation unit 3-12.

Processing which is performed in a case where the operation device has been connected to the cloud browser application is described with reference to FIG. 14B.

First, in step S14-201, the CPU 3-01 starts connection waiting for the operation device via, for example, the menu illustrated in FIG. 9. Next, in step S14-202, the CPU 3-01 receives screen size information about the connected operation device, and, in step S14-203, the CPU 3-01 transmits the screen size information to the cloud browser system 1-00. In step S14-204, the CPU 3-01 receives image data rendered by the cloud browser system 1-00 in conformity with the screen size. In step S14-205, the CPU 3-01 updates, with the received image data, image data which is displayed on the operation device via the server function unit 3-56.

Next, in step S14-206, the CPU 3-01 receives an operation content performed on the operation device. In steps S14-207, S14-208, and S14-209, the CPU 3-01 performs processing similar to that in steps S14-006, S14-007, and S14-008.

Next, if the received operation content is “screen transition” such as page updating by a new URL or screen scroll (SCREEN TRANSITION in step S14-209), then in step S14-210, the CPU 3-01 transmits an image data request to the cloud browser system 1-00. In step S14-211, the CPU 3-01 receives image data from the cloud browser system 1-00.

If the received determination content is “entry field” (ENTRY FIELD in step S14-209), then in step S14-212, the CPU 3-01 transmits a character input request to the operation device, and, in step S14-213, the CPU 3-01 receives input characters from the operation device. Next, in step S14-214, the CPU 3-01 transmits the input characters to the cloud browser system 1-00, and, in step S14-215, the CPU 3-01 receives image data from the cloud browser system 1-00.

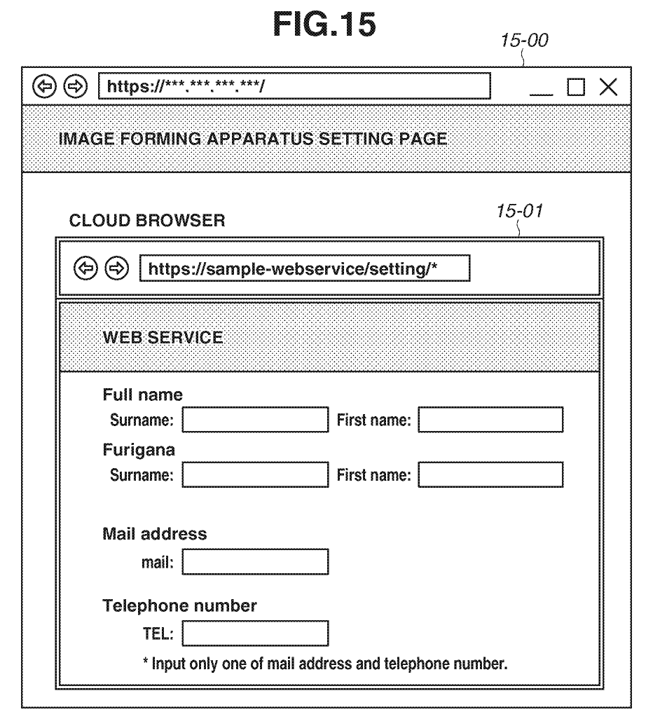

FIG. 15 is a diagram illustrating an example of a web page for performing setting of a web service in the present exemplary embodiment.

A web page screen 15-00 is a screen which is displayed on the user terminal 8-00 via the server function of the image forming apparatus. A web page 15-01 accessed by the cloud browser system, which is displayed in the web page screen 15-00, is the same web page as that illustrated in FIG. 13A. Since the image data size which is received from the cloud browser system depends on the window size which is displayed by the user terminal, a larger range can be displayed than in a case where the web page is displayed on the operation unit 3-12 of the image forming apparatus. Moreover, in inputting of a full name or authentication characters, since the IME of the operation device is used, kanji characters or special symbols can also be input. Moreover, text on a clipboard of the user terminal can also be input.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

The present disclosure can be applied to a system configured with a plurality of devices and can also be applied to an apparatus configured with a single device. For example, part of software modules can be configured to be executed by an external server, and a result of processing performed by the external server can be acquired to implement functions of the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An image forming apparatus comprising:
a first display;
a server function;
one or more memories that store instructions; and
one or more processors that execute the instructions to:
transmit, to a server, a request to render a first web page based on size information of a second display of an external apparatus;
receive, from the server, a rendered image which is generated by rendering the first web page based on the size information of the second display by the server;
update data for a second web page to be provided using the server function of the image forming apparatus so that the rendered image is embedded as web content within the second web page in a format accessible through a web browser; and
provide the updated data to the external apparatus using the server function, wherein the second web page including the rendered image is displayed by a web browser of the external apparatus based on the updated data.

2. The image forming apparatus according to claim 1, wherein the request includes address information about the first web page in addition to the size information.

3. The image forming apparatus according to claim 1, wherein the second web page is a web page for receiving character inputting using a character input system included in the external apparatus, and input information input to the second web page is communicated to the server via the image forming apparatus.

4. The image forming apparatus according to claim 1, wherein the image forming apparatus and the external apparatus are configured to establish a wireless local area network (LAN) connection, and the second web page generated by the image forming apparatus is provided to the external apparatus via the wireless LAN connection.

5. The image forming apparatus according to claim 4, wherein, in a case where the external apparatus establishes the wireless LAN connection with the image forming apparatus using a connection screen displayed by the first display of the image forming apparatus, the image forming apparatus receives a predetermined request from the external apparatus via the wireless LAN connection, and
wherein the image forming apparatus transmits, to the server, the request to render the first web page according to the predetermined request.

6. The image forming apparatus according to claim 1, wherein the image forming apparatus and the external apparatus are configured to perform short-range wireless communication with each other.

7. The image forming apparatus according to claim 1, wherein the second web page comprises a structured web page document in a hypertext markup language (HTML) format, and the second rendered image is embedded within the structured web page document as a web element accessible through the web browser of the external apparatus.

8. A method for an image forming apparatus including a first display and a server function, the method comprising:
transmitting, to a server, a request to render a first web page based on size information of a second display of an external apparatus;
receiving, from the server, a rendered image which is generated by rendering the first web page based on the size information of the second display by the server;
updating data for a second web page to be provided using the server function of the image forming apparatus so that the rendered image is embedded as web content within the second web page in a format accessible through a web browser; and
providing the updated data to the external apparatus using the server function, wherein the second web page including the rendered image is displayed by a web browser of the external apparatus based on the updated data.

9. The method according to claim 8, wherein the request includes address information about the first web page in addition to the size information.

10. The method according to claim 8, wherein the second web page is a web page for receiving character inputting using a character input system included in the external apparatus, and input information input to the second web page is communicated to the server via the image forming apparatus.

11. The method according to claim 8, wherein the image forming apparatus and the external apparatus are configured to establish a wireless local area network (LAN) connection, and the second web page generated by the image forming apparatus is provided to the external apparatus via the wireless LAN connection.

12. The method according to claim 11, wherein, in a case where the external apparatus establishes the wireless LAN connection with the image forming apparatus using a connection screen displayed by the first display of the image forming apparatus, the image forming apparatus receives a predetermined request from the external apparatus via the wireless LAN connection, and
wherein the image forming apparatus transmits, to the server, the request to render the first web page according to the predetermined request.

13. The image forming apparatus according to claim 8, wherein the image forming apparatus and the external apparatus are configured to perform short-range wireless communication with each other.

14. The image forming apparatus according to claim 8, wherein the second web page comprises a structured web page document in a hypertext markup language (HTML) format, and the second rendered image is embedded within the structured web page document as a web element accessible through the web browser of the external apparatus.
